(19) United States
(12) Patent Application Publication
(10) Pub. No.: US 2016/0240102 A1
(43) Pub. Date: Aug. 18, 2016

(54) SYSTEM FOR AUDIO-TACTILE LEARNING WITH RELOADABLE 3-DIMENSIONAL MODULES

(71) Applicants: Vikram BARR, Elkridge, MD (US); Zachary Koung, Elkridge, MD (US); Andrew POWELL, Elkridge, MD (US); Nathan ROY, Elkridge, MD (US)

(72) Inventors: Vikram BARR, Elkridge, MD (US); Zachary Koung, Elkridge, MD (US); Andrew POWELL, Elkridge, MD (US); Nathan ROY, Elkridge, MD (US)

(21) Appl. No.: 14/621,330

(22) Filed: Feb. 12, 2015

(51) Int. Cl. G09B 21/00

(52) U.S. Cl. CPC G09B 21/007; G09B 21/003

(57) ABSTRACT

A system for enhanced learning that combines tactile surfaces and audio recordings, allowing the user to explore a 3-dimensional object through touch while also hearing pre-recorded audio explaining regions or features of interest. One of a collection of 3-dimensional tactile modules is used with the system at a given time. When a tactile module is inserted into the system (or otherwise connected) by the user, the system automatically recognizes the inserted module, locates the set of audio recordings and region maps associated with that tactile module, and then plays module-specific audio recordings.

As the user explores the tactile surface, the system is continually alert for a signal from the user that he/she would like to know more about a particular feature or sub-region of the surface. When such a signal is detected, the system automatically plays a specific audio recording containing information associated with that region of the tactile surface. A region map, stored in memory along with the set of audio recordings for a specific tactile module links specific audio recordings to specific regions of interest.

### TECHNICAL FIELD

The present invention generally relates to educational tools and more particularly, to assistive learning devices for the visually impaired.

### BACKGROUND OF THE INVENTION

Children, as well as adults, who are visually impaired or blind sometimes encounter additional challenges when trying to learn about certain subjects, such as chemistry. With limited or no use of their sight, such a person must rely on his/her senses of hearing and touch, in particular, to a greater degree than the sighted. For example, such a person may listen to an audiobook describing the periodic table, use his/her fingertips to read a description of an element in Braille, or touch samples of elements that are readily available and safe to handle.

Unfortunately, it is not possible or safe to touch many of the objects that are interesting and useful to study. For example, a blind person cannot touch a strand of DNA to fully understand its double-helical shape as easily as she could, say, a banana. This problem applies to several whole classes of objects—that are one or more of: too small, too large, too hot, too cold, or too far away—to touch. A person with sight does not have this problem because he/she can use his/her eyes to study and understand photographs and drawings of such objects.

One existing solution to this problem is to employ a 3-dimensional model of an object of interest. As a visually impaired person touches the model, a sighted person can assist the student by offering information about the features currently being touched. For example, as a student touches a 3-dimensional model of a strand of DNA the instructor can give names to important features and provide additional information related to those features. The recent emergence of low-cost 3D printers holds promise for reducing the cost of such models and increases their availability to teachers, but does not change the learning process.

A limited number of special-purpose 3-dimensional models are equipped with learning features to aid the visually impaired user. For example, there are models of the Earth with tactile continents that are labeled in Braille and/or have associated audio recordings. However, these learning tools are expensive and only available for a small number of subjects of interest.

### SUMMARY OF THE INVENTION

A learning tool of the present invention recognizes both a 3-dimensional object or model being examined by the student and the region of the 3-dimensional object or model being examined and automatically plays one or more audio recordings containing information associated with the regions of interest to the user. To increase the number of educational subjects that can be learned in this way, the learning tool of the present invention should be reloadable so that a large set of inexpensive 3-dimensional objects or models could be used with it. Additionally, learning tool of the present invention is expandable meaning that additional 3-dimensional objects or models may become available for use with the learning tool, and the information contained within the learning tool is updateable in that the information pertaining to one or more of the 3-dimensional objects can be updated, amended, or replaced.

### BRIEF DESCRIPTION OF THE DRAWINGS

FIG. 1 is a block diagram of a preferred embodiment of the present invention;

FIG. 2 is a perspective view of a sample tactile module of a preferred embodiment of the present invention;

FIG. 3 is a top-down view of one aspect of the pin board of a preferred embodiment of the present invention;

FIG. 4 is a cut-away side view of the pin board of a preferred embodiment of the present invention;

FIG. 5 is a flow chart of the central processes of a preferred embodiment of the present invention; and

FIG. 6 is the user's experience of a preferred embodiment of the present invention.

### DETAILED DESCRIPTION

In the following detailed description of the present invention, numerous specific details are set forth in order to provide a thorough understanding of the present invention. However, it will be recognized by one skilled in the art that the present invention may be practiced without these specific details or with equivalents thereof. In other instances, well-known methods, procedures, components and circuits have not been described in detail as not to unnecessarily obscure aspects of the present invention.

Accordingly, what is needed is a system that can be used with a set of removable 3-dimensional tactile modules, each of which has associated with it a set of audio recordings describing features or regions of interest on the surfaces. Such a system should be reloadable so that the user can insert different tactile modules to learn about different educational subjects.

The present invention provides a unique learning experience by allowing a user to explore a 3-dimensional surface through his sense of touch at his own pace. As he locates a feature or region of interest on the tactile surface of the 3-dimensional object or model being examined, the user is able to signal his interest in learning more about a specific feature or region. In response to such a signal from the user, the present invention plays a region-associated informational audio recording via speakers or headphones.

For user convenience, the portion of the system that stores data associated with tactile modules, including the informational audio recordings, may consist of a removable memory device such as a USB-connected disk, SD or Micro-SD card, or any similar removable memory device. An advantage of such a design would be that users could install the audio recordings and other data associated with a new tactile surface by swapping memories or upgrading the contents of a memory device. Alternatively, this data may be made part of, or reside within, the tactile module itself.

An optional network interface, such as Ethernet or WiFi, would allow for a connection to a local area network (LAN) or the Internet. Such connectivity would ease the process of updating the software and data in the system. Access to the Internet could also facilitate additional methods of adding support for new tactile surfaces, including subscription-based access to all of the audio for all of the educational modules from a single publisher to open source community-generated libraries of educational modules.

The combination of a tactile module with associated informational audio recordings and other data is referred to herein as an educational module. The ability to use the present invention with a plurality of educational modules is a central feature of the invention. It allows the system to be reloadable and, thus, the user to use the system to learn about any subject of interest.

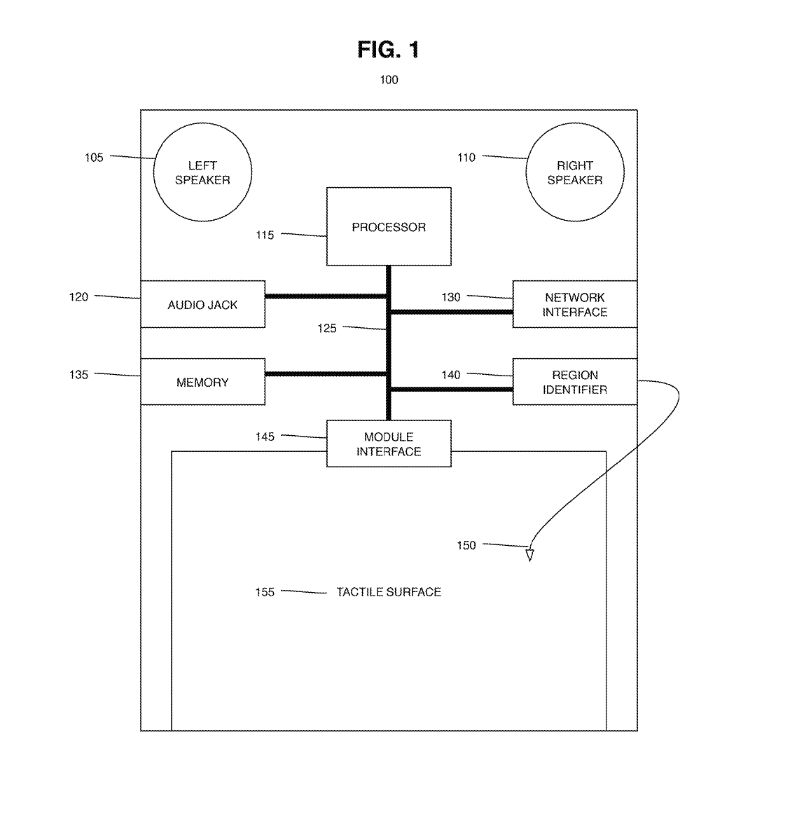

Referring now to the invention in more detail, in FIG. 1 there is shown a block diagram of a preferred embodiment. In this embodiment, a processor 115, which runs specialized software, lies at the heart of the learning system 100. Processor 115 is connected to a number of peripheral devices via bus 125.

Of most significance for the learning experience are the memory 135, region selector 140, and module interface 145 peripherals. A user is able to explore the tactile surface 155 through his sense of touch at his own pace. As he locates a feature of interest on tactile surface 155, he may employ indicator device 150 to signal processor 115. In response to this signal, processor 115 identifies and plays a region-associated audio recording, from memory 135, via the speakers 105, 110 or audio jack 120.

One of a range of methods could be supplied for the user to generate such an indicator signal. For example, an electronic circuit could be completed between the region identifier 140 and processor 115 via the indicator device 150 and via a sub-region of tactile surface 155 and then via module interface 145 and bus 125. Alternatively, region identifier 140 could be implemented as a CCD or other camera-like device that allows the processor 115 to observe the locations and gestures of the user's fingers on tactile surface 155 optically. One of ordinary skill in the art would understand additional methods to generate the indicator signal.

Components left speaker 105, right speaker 110, and audio jack 120 may be present and used in several configurations. That is, the learning process can succeed when used with the included set of stereo speakers (shown in FIG. 1) or a single speaker, with the user wearing headphones connected via audio jack 120 or with a set of external speakers attached via audio jack 120.

Note that memory 135 is not limited to a specific type of memory, and may include any of the following types of memory, without limitation, volatile working memory (e.g., RAM) and non-volatile code and data store memory (e.g., flash). These different memory types may be located in: (i) one or more separate integrated circuit packages connected to processor 115 via an external memory bus or (ii) on-chip within the processor 115 package connected via an internal memory bus or (iii) some combination of both.

Furthermore, at least the portion of memory 135 that stores data associated with educational modules, including audio recordings, may comprise a removable memory device such as a USB-connected disk, SD or Micro-SD card, or any similar removable memory device. An advantage of such a design would be that users could install the audio recordings and other data associated with a new tactile surface by swapping or upgrading the contents of removable memory devices.

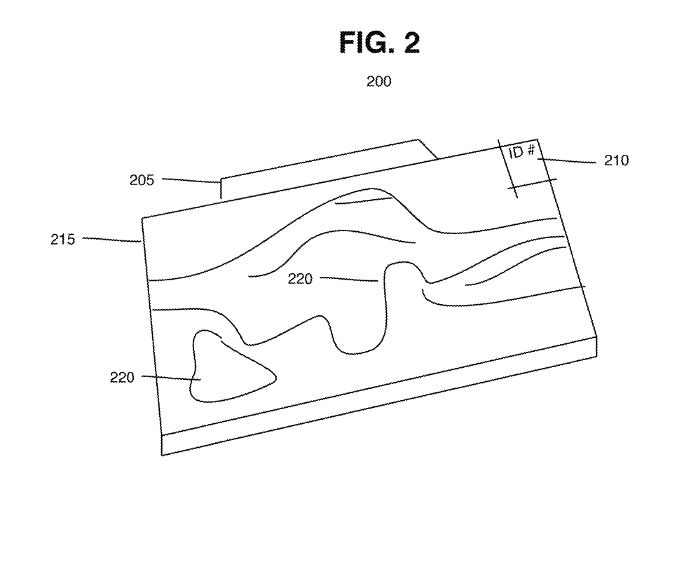

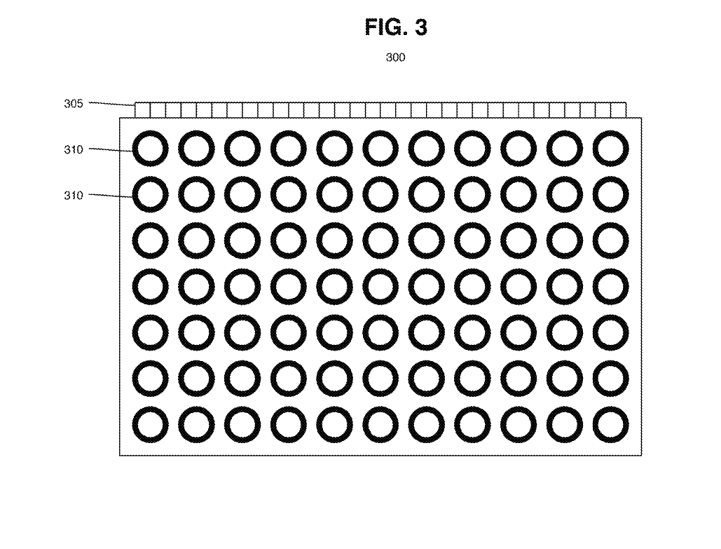

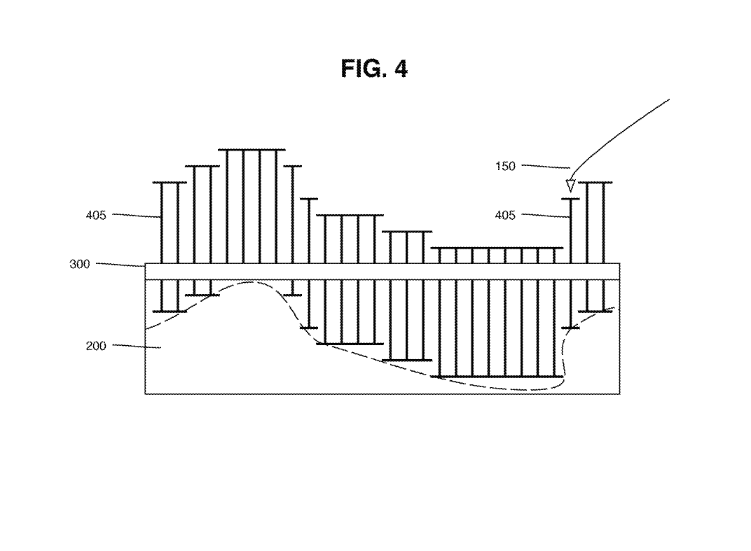

The module interface 145 is the interface between processor 115 and tactile surface 155. This could be implemented in a number of ways, such as via an electronic connector as illustrated in FIG. 2 and described below, or as illustrated in FIG. 3 and FIG. 4 and described below, or as a CCD or other camera-like device that allows the processor 115 to examine tactile surface 155 optically. One of ordinary skill in the art would appreciate additional implementations.

Optional network interface 130 is to provide a wired (e.g., Ethernet) or wireless (e.g., 802.11) connection to a LAN or the Internet. Inclusion of a network interface 130 would ease the process of updating the software in the system 100 as well as the data in memory 135. Access to the Internet could also facilitate additional methods of adding support for new tactile surfaces, including subscription-based access to all of the audio for all of the educational modules from a single publisher to open source community-generated libraries of educational modules.

Referring now to FIG. 2, which shows a preferred embodiment of a 3-dimensional object/model, or a “tactile module” 200, a 3-dimensional surface 215 contains a variety of height-differentiated features, such as topological element 220. Each tactile module 200 may also contain optional module connector 205 and optional module identifier 210. If present, module connector 205 engages with module interface 145. One of ordinary skill in the art would appreciate that the connection between module connector 205 and module interface 145 would preferably be wireless such that the module connector would not appear to be a portion of the 3-dimensional object/model to the student.

The combination of the audio recordings and other data stored in memory 135 and an associated tactile module 200 is what is referred to herein as an educational module. The ability to use learning tool 100 with a plurality of educational modules is a central feature of the invention. It is the reason the invention is said to be reloadable. In other words, the sample 3-dimensional object/model shown in FIG. 2 is just one of a plurality of 3-dimensional objects/models which would be included within the present invention.

Note that in a preferred embodiment each tactile module 200 has the same width and length and a maximum supported height. However, in another embodiment a tactile module 200 is simply any 3-dimensional object that learning tool 100 is capable of recognizing. In either case, one method of delivering a new tactile module 200 is for the owner of a learning tool 100 to download a model of a 3-dimensional object and print said object on a 3D printer, such as a MakerBot. After also downloading the audio recordings and other data associated with new tactile module 200 into memory 135, the user would then have a new educational module.

A module identifier 210 is, for example and without limitation, a UPC (Universal Product Code) code, QR (Quick Response) code, pattern of raised dots (e.g., Braille), or other consistent labeling means by which processor 115 can recognize one tactile module 200 and distinguish it from another. For example, if each tactile module 200 has a unique UPC code in its upper right corner, then module identifier 210 could be read by the processor 115 (e.g., via a bar code reader peripheral) to recognize the installed tactile module 200.

Alternatively, a module identifier 210 may be omitted altogether by pairing a removable memory 135, such as an SD card, with each tactile surface. In this design the user removes and inserts both a tactile module 200 and an associated memory 135 when changing from one educational module to another.

In one embodiment, memory 135 may be integrated into a tactile module 200 and become connected to processor 115 via module interface 145 and module connector 205. An advantage of this design is that the audio recordings and other data associated with a tactile module 200 are stored within the tactile module itself, thereby simplifying the user experience. Learning tool 100 is then able to support any installed tactile module 200 without the need for memory card swaps, memory updates, or network connections, and also without the need for a mechanism to recognize the module identifier 210.

Referring now in more detail to some of the interfaces between the tactile module and the rest of the system, a top view of an aspect of a preferred embodiment of this subsystem is illustrated in FIG. 3. Pin board 300 is, for example and without limitation, an electronic circuit board consisting of a 2-dimensional matrix of pin holes 310 each with a conductive cylindrical lining with a fixed inner dimension. Into each pin hole 310 is installed a conductive pin of approximately the same outer dimension. The pins are not visible in the top-down view of FIG. 3, but are visible as pins 405 in the cut-away side view of FIG. 4, which is described below.

In a preferred embodiment of pin board 300, each of the pin holes 310 is conductively coupled to module interface 145 via pin board connector 305. These electrical signals could either flow each to a general purpose input pin on processor 115 or be consolidated and routed onto bus 115 via the module interface 145.

Referring now to the cut-away side view of the tactile surface 155 as illustrated in FIG. 4, pin board 300 is shown with pins 405 moving up and down through their respective pin holes 310. Note that each pin 405 is conductively coupled to its pin hole 310, irrespective of its height, so that the user can signal processor 115 by touching indicator device 150 to one of the pins 405 in a region of interest. For example, the sharp rise in tactile module 200 where indicator device 150 is shown, in FIG. 4, touching a pin 405, is at a sharp rise in the 3-dimensional surface. An audio recording containing information about that feature of the surface would be played by processor 115 in reaction to the electrical signal from the user at that specific pin hole 310.

The pin board 300 described above and illustrated in FIGS. 3 and 4 is a means for recognizing a signal from the user about regions of interest. Where a pin board 300 is used, the user touches the pin board to explore the tactile surface (indirectly) rather than directly touch the tactile module 200. That is, the tactile module 200 is inserted below the pin board 300. Each of the pins 405 of the pin board is pushed up by the point of the tactile module 200 that sits below it.

For the learning tool 100 to support an educational module, each tactile module 200 preferably would have associated with it a set of audio recordings, including at least an initial module overview recording and a plurality of region-associated informational audio recordings stored in memory 135 or, in the alternative, accessible via network interface 130. Furthermore, it is desirable to have a region map to place each pin 405 into up to one informational audio recording regions. This region map may also be stored in memory 135 or be accessible via network interface 130.

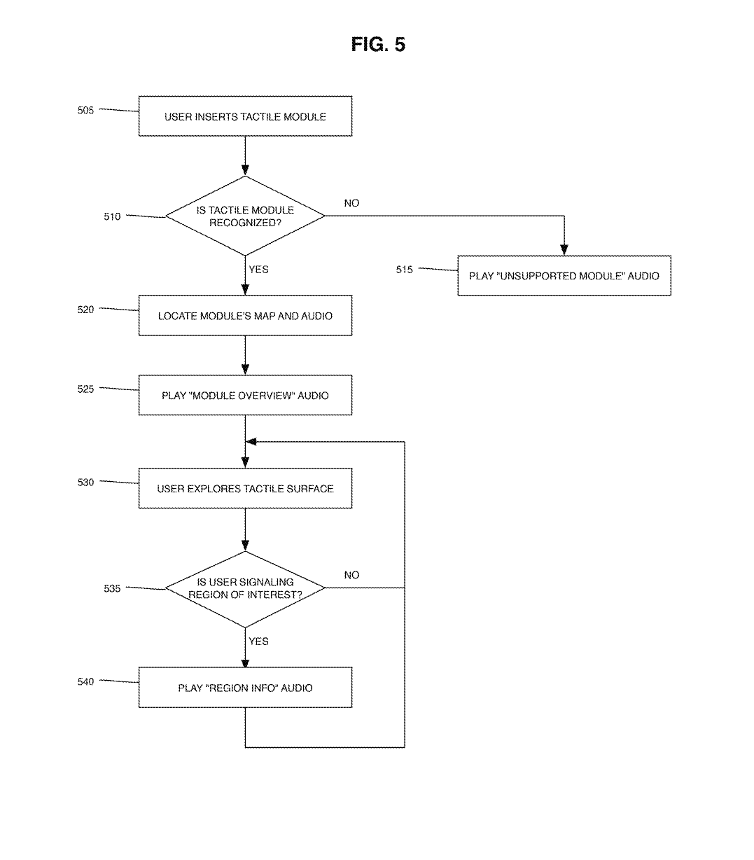

The process by which the system preferably operates is illustrated in FIG. 5. After a user inserts a tactile module of his selection, at step 505, the system attempts to recognize the inserted tactile module, at step 510. This step 510 could be done, for example, by examination of a module identifier as described above. If it is determined that the inserted tactile module is not recognized, the system plays an audio recording informing the user that the tactile module is unsupported, at step 515.

After an inserted tactile module is recognized, the system locates the region map and set of audio recordings associated with that tactile module, at step 520. Next the system plays an audio recording that provides the user an overview of the inserted tactile module, at step 525.

As the user explores the tactile surface, at 530, the system waits for a signal from the user, at step 535. When a signal from the user is received, the system looks at the location of the signal (e.g., considers the pin number on the pin board) and uses the region map associated with the inserted tactile module to identify and play the region-specific informational audio recording, at step 540. This process continues until the user has completed using the tactile module.

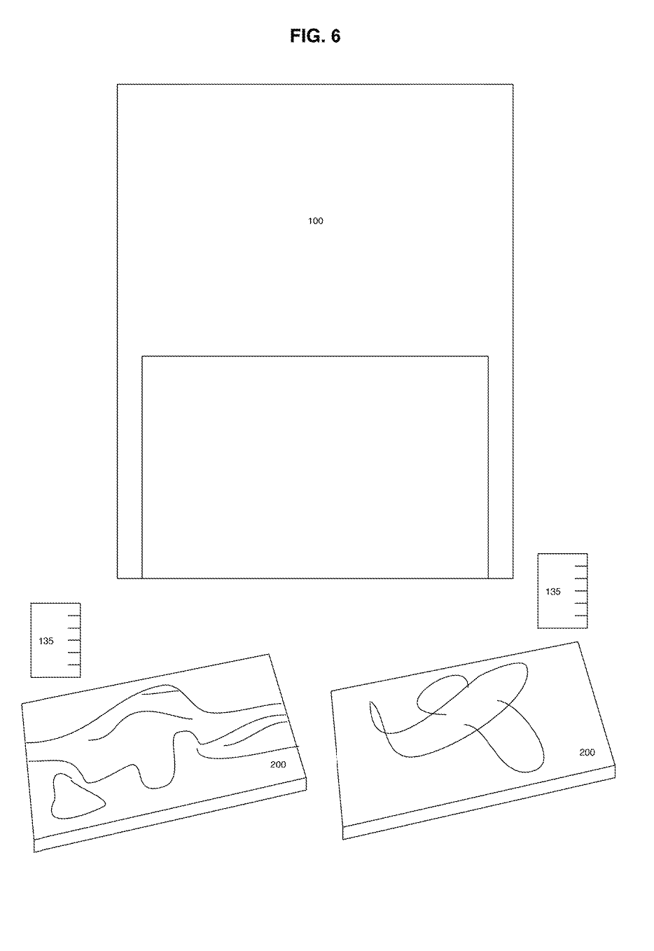

Referring now to FIG. 6, a preferred embodiment of the present invention consists of a learning tool 100 for use in conjunction with a plurality of tactile modules 200, each of which is preferably associated with a removable memory 135. To use this system, the user inserts a first tactile module 200, such as a 3D model of a topological feature, in combination with its associated memory 135 into learning tool 100. He/she then explores the tactile surface through touch and signals learning tool 100 to play one or more audio recordings from memory 135. When the user is done learning from that first educational module, he/she removes first tactile module 200 and associated memory 135 from learning tool 100 then replaces those with second tactile module 200, such as a 3D model of an aircraft, in combination with its associated memory 135 and explores the new surface.

For example, a blind person could use a learning tool of the present invention to learn about dinosaurs. In this scenario, a school or student purchases a plurality (or set) of different 3-dimensional model dinosaurs that work with the learning tool. When the student wants to learn about the Tyrannosaurus (T-Rex) he/she locates the T-Rex tactile module and inserts it into the learning tool 100. Now either the learning tool 100 recognizes the T-Rex tactile module automatically or the student inserts an associated removable memory 135 into learning tool 100. Once the T-Rex tactile module 200 is inserted/recognized, the student could then signal that the jaws of the T-Rex are of interest and receive information as to the number of teeth a T-Rex had at one time, the number of replacement teeth the T-Rex had during its lifetime, the pounds per square inch the T-Rex's jaw could exert, etc. When the student later signals that the legs of the T-Rex are a region of interest, the learning tool plays an audio recording providing information about the length of its legs and the top speed the animals. Conversely, when the Velociraptor tactile module is paired with the learning tool, the student would receive information on the Velociraptor.

An alternate set of 3-dimensional models that may be offered with the learning tool of the present invention, is a set of 3-dimensional objects/models associated with U.S. military aircraft (for example). When the learning tool 100 is paired with an SR-71 Blackbird aircraft tactile module 200, the student can signal that different parts of the Blackbird aircraft are of interest to be presented with audio recording about those aspects. For example, when a wing of the Blackbird aircraft is indicated, for example and without limitation, the student may be presented with information pertaining to the angle of attack of the wing or the variations of the angle of attack of the wing along its length.

Among the advantages of the present invention are that, by comparison with tactile-only learning tools, information about specific features or regions of 3-dimensional objects or tactile surfaces can be provided automatically to the user without requiring a sighted teacher to provide such information. In addition, the present invention improves upon books written in Braille as well audio-books, which, even if they contain precisely the same information as the set of audio recordings described above, are necessarily limited in that the user cannot involve his sense of touch to augment the information to gain additional insights. Furthermore, the present invention improves upon fixed-surface tactile-audio systems, such as talking globes, by being reloadable and thereby supporting a plurality of educational modules potentially covering a huge range of topics.

Furthermore, the same system could be used in contexts other than learning. For example, a system that is able to recognize a plurality of 3-dimensional objects could also be used to inform vision-impaired users of such an object that a hazard is present (e.g., a sharp corner or a hot spot). Additionally, such a system could be used to inform a user of a 3-dimensional object that there is a button or a knob near his fingers so that he can more easily interact with the object.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

What is claimed is:

1. A system combining tactile and audio feedback, said system comprising:
a processor;
a plurality of tactile modules;
a means for recognizing a first of said tactile modules;
a means for recognizing a signal from the user to indicate a region of interest of said first tactile module;
a memory coupled to said processor and having stored therein a plurality of sets of audio recordings each associated to said first tactile module; where said system performs the steps of:
recognizing said first tactile module;
locating a set of audio recordings located within said memory associated with said first tactile module;
playing a first audio recording from said set of audio recordings providing information about said first tactile module;
recognizing a said signal from the user to indicate a first region of interest within said first tactile module; and
playing a second audio recording from the set of audio recordings that provides information associated with said first region of interest.

2. The system as recited in claim 1 wherein said tactile modules are cartridges of a fixed width and depth and maximum height and mechanically inserted into said system.

3. The system as recited in claim 1, wherein said tactile modules can be 3D printed by the user.

4. The system as recited in claim 1 wherein said means for recognizing a first of said tactile modules includes reading a UPC code or similar data bar located on said tactile module.

5. The system as recited in claim 1 wherein said means for recognizing a first of said tactile modules includes reading a QR code or similar data matrix located on said tactile module.

6. The system as recited in claim 1 wherein said means for recognizing a first of said tactile modules includes reading Braille or another pattern of raised dots located on said tactile module.

7. The system as recited in claim 1 wherein said means for recognizing a first of said tactile modules includes reading an electronic code from said tactile module.

8. The system as recited in claim 1 wherein said means for recognizing a first of said tactile modules includes examination of said tactile module with a CCD or similar digital camera device.

9. The system as recited in claim 1 wherein said means for recognizing a signal from the user to indicate a region of interest within said tactile module includes an electronic signal.

10. The system as recited in claim 1 wherein said means for recognizing a signal from the user to indicate a region of interest within said tactile module includes observation of the finger movements with a CCD or similar digital camera device.

11. The system as recited in claim 1 wherein said memory is an Internet website accessible over a network interface.

12. The system as recited in claim 1 wherein said memory comprises an SD card or similar removable memory cartridge.

13. The system as recited in claim 12 wherein said memory is attached to said tactile module.

14. A system combining tactile and audio feedback, said system comprising:
a processor;
a plurality of tactile modules;
a plurality of conductive pins coupled to said processor;
a pointer to provide an electronic signal from the user to indicate a region of interest within said tactile module, through a said conductive pin;
a memory unit coupled to said processor and having stored therein a plurality of sets of audio recordings each associated to a said tactile module; where said system performs the steps of:
recognizing a first tactile module;
locating a set of audio recordings associated with said first tactile module;
playing a first audio recording from said set of audio recordings providing information about said first tactile module;
recognizing a said signal from the user to indicate a region of interest within said tactile module; and
playing a second audio recording from the first set of audio recordings that associates information with said region of interest.

15. The system as recited in claim 14 wherein said tactile modules are cartridges of a fixed width and depth and maximum height and mechanically inserted into said system.

16. The system as recited in claim 14, wherein said tactile modules can be 3D printed by the user.

17. The system as recited in claim 14 wherein said memory is an Internet website or similarly accessible over a network interface.

18. The system as recited in claim 14 wherein said memory comprises an SD card or similar removable memory cartridge.

19. The system as recited in claim 18 wherein said memory is attached to said tactile module.
